(19) United States
(12) Patent Application Publication
(10) Pub. No.: US 2016/0269316 A1
(43) Pub. Date: Sep. 15, 2016

(54) ACCEPTANCE DEVICE,ACCEPTANCE SYSTEM, ACCEPTANCE METHOD, AND PROGRAM

(71) Applicant: C-GRIP CO., LTD., Kanazawa-shi, Ishikawa (JP)

(72) Inventor: Hidemi KUROGUCHI, Ishikawa (JP)

(21) Appl. No.: 14/909,670

(22) PCT Filed: Aug. 28, 2014
(86) PCT No.: PCT/JP2014/072626

§ 371 Date: Feb. 2, 2016

(51) Int. Cl. H04L 12/927; H04L 29/08

(52) U.S. Cl. CPC H04L 47/803; H04L 67/10

(57) ABSTRACT

To alleviate the bother of web acceptance.

An acceptance system includes a web server that conducts web acceptance, and an acceptance device that conducts phone acceptance. A client terminal browses or operates a web page provided by the web server. The web server comprises: an access information registration section that registers browse/operation information about the browse or operation of the web page by the client terminal, such that the information is correlated with a phone number of the client terminal; and a transmitting section that transmits browse/operation information registered by the access-information registration section, to the acceptance device in accordance with a request from the acceptance device. The acceptance device comprises: an access information acquiring section that acquires, from the web server, the browse/operation information registered by the access information registration section, such that the information is correlated with the phone number of the client; a number specifying section that specifies the phone number of the client terminal on the basis of a call signal from a phone call made by the client terminal; and a client information providing section that provides information indicating a content browsed or operated on the web page by the client, on the basis of the phone number specified by the number specifying section and the browse/operation information acquired by the access information acquiring section.

### TECHNICAL FIELD

The present invention relates to an acceptance device, acceptance system, acceptance method, and program.

### BACKGROUND

For example, Patent Literature 1 discloses a vehicle-dispatching management system from which a district such as a prefecture or a municipality is retrieved on the basis of GPS data from a GPS reception means provided for a mobile phone or the like used by a client. Additionally, the Patent Literature 1 also discloses the dial retrieval function of retrieving, on the basis of dial data such as a phone number or dial number from a client terminal, a destination to which a vehicle is dispatched.

### PRIOR TECHNICAL LITERATURE

### Patent Document

Patent Literature 1: JP 2002-245134A

### SUMMARY OF THE INVENTION

### Problem to be Solved by the Invention

An object of the present invention is to provide an acceptance system that alleviates the bother of web acceptance.

### Method for Solving the Problem

According to an aspect of the invention, there is provided an acceptance device comprising: an access information acquiring section that acquires browse/operation information about browse or operation of a web page by a client such that the information is correlated with the phone number of the client; a number specifying section that specifies the phone number of the client on the basis of a call signal from a phone call made by the client; and a client information providing section that provides information indicating a content browsed or operated on the web page by the client, on the basis of the phone number specified by the number specifying section and the browse/operation information acquired by the access information acquiring section.

Preferably, the access information acquiring section acquires, as the browse/operation information, information about search conducted on the web page in accordance with an instruction from the client, and the client information providing section provides a phone operator currently engaged with a phone due to the call signal, with information about the latest search of the searches conducted on the web page by the client.

Preferably, the web page is a reservation reception site and the access information acquiring section acquires at least information specifying an object for reservation and information about reservation time and date and the client information providing section provides the phone operator with information about the object for the reservation and the reservation time and date in the latest search.

Preferably, the access information acquiring section acquires, as the browse/operation information, information specifying the web page accessed most recently by the client and the client information providing section provides an operator currently engaged with the phone due to the call signal, with the web page accessed most recently by the client, on the basis of information acquired by the access information acquiring section and the acceptance device further comprises an edit permitting section that gives the phone operator an editorial right for the web page provided by the client information providing section, and the web page browsed or operated by the client is shared with the phone operator.

Preferably, the acceptance device further comprises a positional-information acquiring section that acquires positional information about the client and the client information providing section provides a phone operator currently engaged with a phone due to the call signal, with information indicating content browsed or operated on the web page by the client and positional information about the client acquired by the positional-information acquiring section.

According to an aspect of the invention, there is provided an acceptance system including a client terminal, a web server, and an acceptance device and the client terminal browses or operates a web page provided by the web server and the web server includes: an access information registration section that registers browse/operation information about the browse or operation of the web page by the client terminal, such that the information is correlated with a phone number of the client terminal; and a transmitting section that transmits browse/operation information registered by the access-information registration section, to the acceptance device in accordance with a request from the acceptance device, and the acceptance device comprises: an access information acquiring section that acquires, from the web server, the browse/operation information registered by the access information registration section, such that the information is correlated with the phone number of the client; a number specifying section that specifies the phone number of the client terminal on the basis of a call signal from a phone call made by the client; and a client information providing section that provides information indicating a content browsed or operated on the web page by the client, on the basis of the phone number specified by the number specifying section and the browse/operation information acquired by the access information acquiring section.

Preferably, the client terminal transmits the positional information of the terminal to the web server and the web server further comprises a positional-information registration section that registers the positional information of the client terminal received from the client terminal, such that the information is correlated with the phone number of this client terminal and the access information acquiring section acquires browse/operation information registered by the access information registration section, and positional information registered by the positional-information registration section and the client-information providing section provides information indicating content browsed or operated on the web page and information indicating the position of the client terminal, on the basis of the phone number specified by the number specifying section.

Preferably, on condition that the positional information of the terminal is transmitted to the web server, the client terminal is enabled to call the acceptance device.

Preferably, on condition that the phone number of the client terminal is specified by the number specifying section, the access information acquiring section acquires browse/operation information correlated with the specified phone number from the web server.

Preferably, the web server further comprises a page providing section that provides the client terminal with a web page in which an operation area for calling the acceptance device is included and the access information registration section registers browse/operation information about a client's browsing or operating a web page, provided by the page providing section, such that the browse/operation information is correlated with the phone number of the client terminal.

According to an aspect of the invention, there is provided an acceptance system including a client terminal, a web server, and an acceptance device, wherein the client terminal browses or operates a web page provided by the web server, and transmits a phone number such that the phone number is correlated with the web page, wherein the web server comprises: an access information registration section that registers browse/operation information about browse or operation of the web page by the client terminal, such that the information is correlated with a phone number received from the client terminal; and a transmitting section that transmits browse/operation information registered by the access-information registration section and the phone number, to the acceptance device in accordance with a request from the client terminal, wherein the acceptance device comprises: an access information acquiring section that acquires, from the web server, browse/operation information registered by the access information registration section, such that the information is correlated with the phone number of the client; a number acquiring section that, when the phone number is registered in the web server, acquires the phone number of the registered client terminal; a client information providing section that provides information indicating content browsed or operated on the web page by the client, on the basis of the phone number acquired by the number acquiring section and the browse/operation information acquired by the access information acquiring section; and a calling section that calls the client terminal via a telephone line on the basis of the phone number acquired by the number acquiring section.

According to an aspect of the invention, there is provided an acceptance device comprising: an access information registration section that registers browse/operation information about browse or operation of a web page by a client terminal such that the information is correlated with the timing of the browse or operation by the client terminal; a timing specifying section that specifies the timing of reception of an incoming call from the client terminal, on the basis of a call signal from a phone call made by the client terminal; and a client information providing section that provides information indicating contents browsed or operated on the web page, on the basis of browse/operation information registered by the access information registration section and a timing specified by the timing specifying section.

According to an aspect of the invention, there is provided an acceptance method, comprising: a step of a client terminal's browsing or operating a web page provided from a web server; a step of the web server's registering browse/operation information about the browse or operation of the web page by the client terminal, such that the information is correlated with a phone number of the client terminal; a step of the client terminal's calling an acceptance device via a telephone line; a step of the acceptance device's specifying the phone number of the client terminal on the basis of a call signal from a phone call made by the client terminal; a step of the acceptance device's acquiring, from the web server, the browse/operation information registered correlated with the phone number; and a step of the acceptance device's providing a phone operator with information about a content browsed or operated on the web page by the client, on the basis of acquired browse/operation information.

According to an aspect of the invention, there is provided a program causing a computer to perform: a step of displaying a link for accessing a web page; a step of transmitting positional information to a web server currently providing the web page, the positional information indicating a position when the web page is being browsed or operated, and the positional information being correlated with the phone number; and a step of, on condition that transmission of the positional information is completed, starting to call a phone number that conducts an acceptance service correlated with the web page.

### Effect of the Invention

The present invention is able to alleviate the bother of web acceptance.

### BRIEF DESCRIPTION OF DRAWINGS

FIG. 1 is a diagram showing an example of the hardware configuration of an acceptance system 1.

FIG. 2 is a diagram showing an example of the hardware configuration of an acceptance device 2.

FIG. 3 is a diagram showing an example of the configuration of functions of the acceptance device 2.

FIG. 4 is a diagram showing an example of the hardware configuration of an acceptance server 7.

FIG. 5 is a diagram showing an example of the configuration of functions of the acceptance server 7.

FIG. 6A is a diagram showing an example of information registered in a user information database 750, FIG. 6B is a diagram showing an example of information registered in an access information database 752, and FIG. 6C is a diagram showing an example of information registered in a positional information database 754.

FIG. 7 is a sequence diagram for a reservation acceptance process (S10) in the acceptance system 1.

FIG. 8 is a diagram showing an example of a reservation website 8.

FIG. 9 is a diagram showing an example of the configuration of functions of an acceptance program 23 in a modified example 1.

FIG. 10 is a sequence diagram for a reservation acceptance process (S20) in the modified example 1.

FIG. 11 is a diagram showing an example of the hardware configuration of an acceptance system 1 in a modified example 2.

FIG. 12 is a diagram showing an example of the configuration of functions of an acceptance device 27 in the modified example 2.

### DESCRIPTION OF EMBODIMENT

With reference to the drawings, an embodiment of the present invention will be described below.

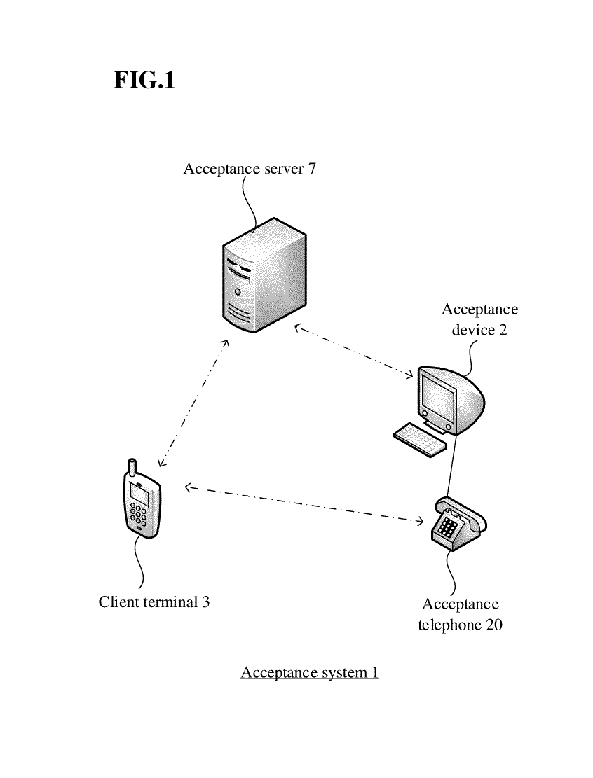

FIG. 1 is a diagram showing an example of the hardware configuration of an acceptance system 1. In the drawing, a single dotted line indicates a telephone line and a double-dotted line indicates an internet line.

As shown in FIG. 1, the acceptance system 1 includes an acceptance device 2 and an acceptance server 7. The acceptance device 2 connects to the acceptance server 7 through a network such as the internet.

A client terminal 3 used by a client connects to the acceptance server 7 via the internet. Additionally, the client terminal 3 connects to the acceptance device 2 via the telephone line.

The acceptance device 2 is an example of the acceptance device according to the present invention and has a telephone (acceptance telephone 20) connected to a public line (telephone line). The acceptance device 2 in the present embodiment is a CTI system, in which the acceptance telephone 20 is integrated, and enables acceptance of phone by a phone operator.

The acceptance server 7 is a web server that conducts an acceptance service of the same type as the acceptance device 2.

The client terminal 3 is a mobile phone used by a client. The client terminal 3 in the present embodiment has the function of acquiring its own positional information by means of GPS, for example.

In the acceptance system 1 in the present embodiment, clients make various reservations and place various orders by using both web acceptance via the internet and phone acceptance via the telephone line. The acceptance device 2 and the acceptance server 7 cooperate to accept reservations and orders from clients. Such orders are, for example, an order for dispatching a taxi or a proxy driver or an order for delivering a pizza. Such reservations are, for example, a reserve-order for a hairdressing salon, beauty clinic, hospital, golf course, osteopathic clinic, or nursery.

Web acceptance has a merit in that the contents of reservation states (a reservable time period, a vacant seat state, and the like), prices and goods, or services can be checked any time at the pace of a client. Meanwhile, reserve-orders and the like have demerits in that various pieces of information have to be entered and, if information on the web is not sufficiently clear, neither party can make inquiries at appropriate times. Additionally, in web acceptance, a client may become uneasy because she or he is not sure that the website operator really exists or that the client's order has definitely been accepted.

Phone acceptance has such merits in that, since an order is accepted through conversation, it seems safer for a client than web acceptance and, depending on a phone operator, she or he may propose a more detailed service through conversation between parties. Depending on, for example, the number of phone operators, a client may be kept waiting for a long time until her or his phone call gets through. Or, an order may be accepted at the pace of a phone operator, and the pace may not match that of a client. Additionally, depending on the ability of a phone operator, she or he may not be able to fully understand a request from a client, so that the client may be irritated.

The acceptance system 1 in the present embodiment realizes efficient acceptance operation through mutual cooperation and complement of phone acceptance with the acceptance device 2 and web acceptance with the acceptance server 7.

Incidentally, there are many examples where phone acceptance and web acceptance simply coexist. However, these do not cooperate with each other. Therefore, for example, if web acceptance is not successful and a change is made to phone acceptance, an order has to be placed again from the beginning, which is inconvenient.

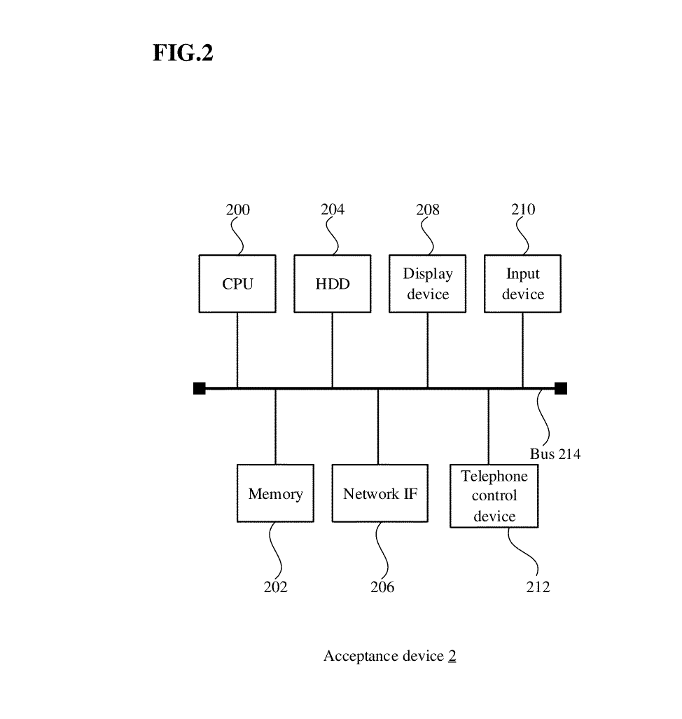

FIG. 2 is a diagram showing an example of the hardware configuration of the acceptance device 2.

As shown in FIG. 2 as an example, the acceptance device 2 comprises a CPU 200, memory 202, HDD 204, network interface 206 (network IF 206), display device 208, input device 210, and telephone control device 212, and the respective configurations of these are connected one another via a bus 214.

The CPU 200 is, for example, a central processing unit.

The memory 202 is, for example, a volatile memory, and functions as a main storage device.

The HDD 204 is, for example, a hard disk drive device, and stores computer programs and other data files as a nonvolatile recording device.

The network IF 206 is an interface for communication by wire or by radio, and achieves communication with the acceptance server 7 via the internet.

The display device 208 is, for example, a liquid crystal display.

The input device 210 is, for example, a keyboard and mouse.

The telephone control device 212 is a control device that controls the acceptance telephone 20, and connects to the acceptance telephone 20 via, for example, a terminal adaptor.

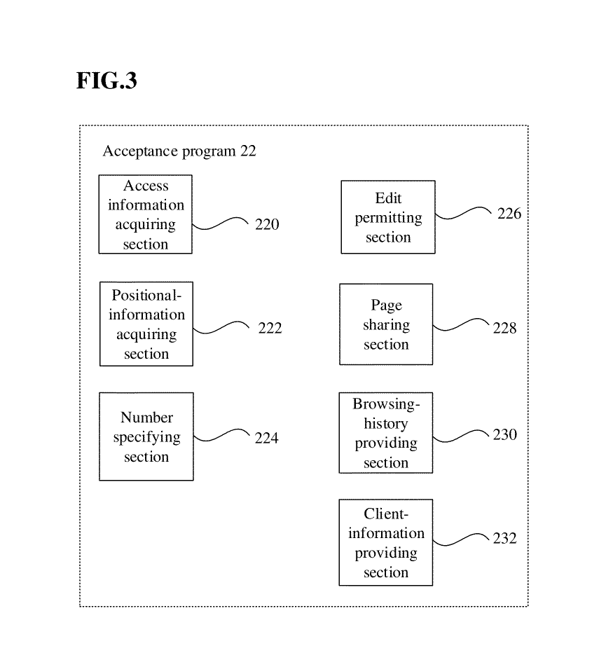

FIG. 3 is a diagram showing an example of the configuration of functions of the acceptance device 2.

As shown in FIG. 3 as an example, an acceptance program 22 is installed in the acceptance device 2 of the present embodiment.

The acceptance program 22 has an access information acquiring section 220, positional-information acquiring section 222, number specifying section 224, edit permitting section 226, page sharing section 228, browsing-history providing section 230, and client information providing section 232.

Part or all of the acceptance program 22 may be achieved by hardware such as an ASIC. The acceptance program 22 is stored in a recording medium, such as a CD-ROM or the like, and installed via this recording medium.

In the acceptance program 22, the access information acquiring section 220 acquires browse/operation information about browse or operation of a web page by a client such that the information is correlated with the phone number of the client. Examples of such browse/operation information are a page ID for specifying a web page to be browsed, information input by a client on a web page, browsing history when a plurality of web pages are browsed, or a condition for and the result of a search conducted on a web page. Examples of a condition for a search include information to specify an objective for reservation and information about reservation time and date. For example, the access information acquiring section 220 acquires browse/operation information for each client from the acceptance server 7 such that the information is correlated with the phone number of the client.

The positional-information acquiring section 222 acquires, via the acceptance server 7, positional information indicating the current position of a client terminal 3. For example, the positional-information acquiring section 222 acquires GPS information, uploaded to the acceptance server 7 via a web page by the client terminal 3, from the acceptance server 7, with the GPS information being correlated with the phone number of the client terminal 3.

The number specifying section 224 specifies the phone number of a client on the basis of a call signal from a phone call made by the client. For example, when the acceptance telephone 20 receives a call signal from a client terminal 3, the number specifying section 224 extracts a number display signal and specifies the phone number of the client terminal 3 on the basis of the number display signal thus extracted.

The edit permitting section 226 gives an editorial right for a web page provided by the client information providing section 232, to the acceptance device 2 of the phone operator. Specifically, the edit permitting section 226 requests the acceptance server 7 for an editorial right for a web page corresponding to a page ID correlated with the phone number (i.e., the number of the phone currently engaged with) specified by the number specifying section 224 from the page ID acquired by the access information acquiring section 220. That is, on condition that a connection in a telephone line has been established between the client terminal 3 and the acceptance device 2, the edit permitting section 226 gives the acceptance device 2 an editorial right for the web page accessed by the client terminal 3.

The page sharing section 228 gives the acceptance device 2 of a phone operator a browsing right for a web page provided by the client information providing section 232. Specifically, the page sharing section 228 requests the acceptance server 7 for a browsing right for a web page corresponding to a page ID correlated with the phone number specified by the number specifying section 224 from the page ID acquired by the access information acquiring section 220. That is, on condition that a connection in a telephone line has been established between the client terminal 3 and the acceptance device 2, the page sharing section 228 gives the acceptance device 2 a browsing right for the web page accessed by the client terminal 3, thus allowing the web page browsed by the client to be shared with the phone operator.

In response to an instruction from the client information providing section 232, the browsing-history providing section 230 provides a phone operator with the browsing histories of web pages browsed by a client. The browsing-history providing section 230 acquires from the acceptance server 7 a web page corresponding to a browsing history selected by the phone operator from among the browsing histories displayed by the client information providing section 232, and causes the display device 208 to display this web page.

On the basis of a phone number specified by the number specifying section 224 and browse/operation information acquired by the access information acquiring section 220, the client information providing section 232 provides information indicating the contents browsed or operated on a web page by a client. For example, the client information providing section 232 causes the display device 208 of a phone operator to display browse/operation information (e.g., a page ID, input information, browsing history, and search result) corresponding to a phone number (i.e., the number of the phone currently engaged with the phone operator) specified by the number specifying section 224. Additionally, the client information providing section 232 in the present embodiment provides the page sharing section 228 with a page ID, thereby causing the display device 208 to display the web page browsed by a client.

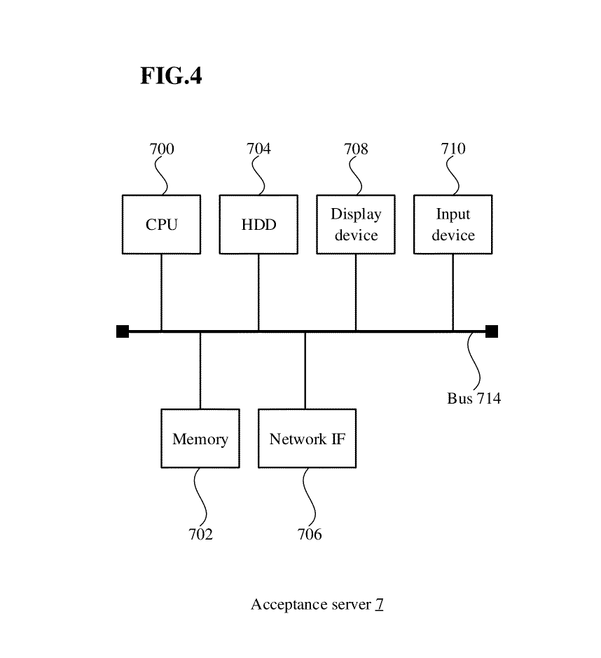

FIG. 4 is a diagram showing an example of the hardware configuration of the acceptance server 7.

As shown in FIG. 4 as an example, the acceptance server 7 comprises a CPU 700, memory 702, HDD 704, network interface 706 (network IF 706), display device 708, and input device 710, and the respective configurations of these are connected one to another via a bus 714.

The CPU 700 is, for example, a central processing unit.

The memory 702 is, for example, a volatile memory, and functions as a main storage device.

The HDD 704 is, for example, a hard disk drive device, and stores computer programs and other data files as a nonvolatile recording device.

The network IF 706 is an interface for communication by wire or by radio, and achieves communication with a mobile terminal 3 via the internet.

The display device 708 is, for example, a liquid crystal display.

The input device 710 is, for example, a keyboard and mouse.

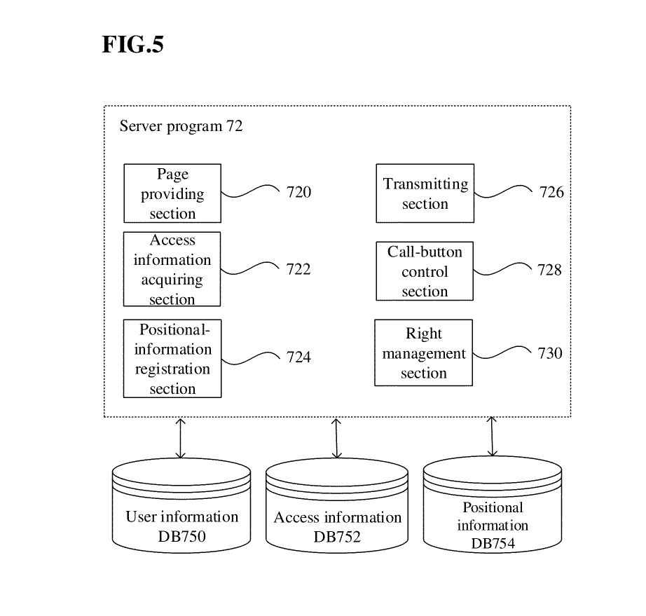

FIG. 5 is a diagram showing an example of the configuration of functions of the acceptance server 7.

As shown in FIG. 5 as an example, a server program 72 is installed in the acceptance server 7 of the present embodiment. Additionally, the server 7 comprises a user information database 750 (user DB 750), access information database 752 (access information DB 752), and positional information database 754 (positional information DB 754).

The server program 72 includes a page providing section 720, access information registration section 722, positional-information registration section 724, transmitting section 726, call-button control section 728, and right management section 730.

Part or all of the server program 72 may be achieved by hardware such as an ASIC. The server program 72 is stored in a recording medium, such as a CD-ROM or the like, and installed via this recording medium.

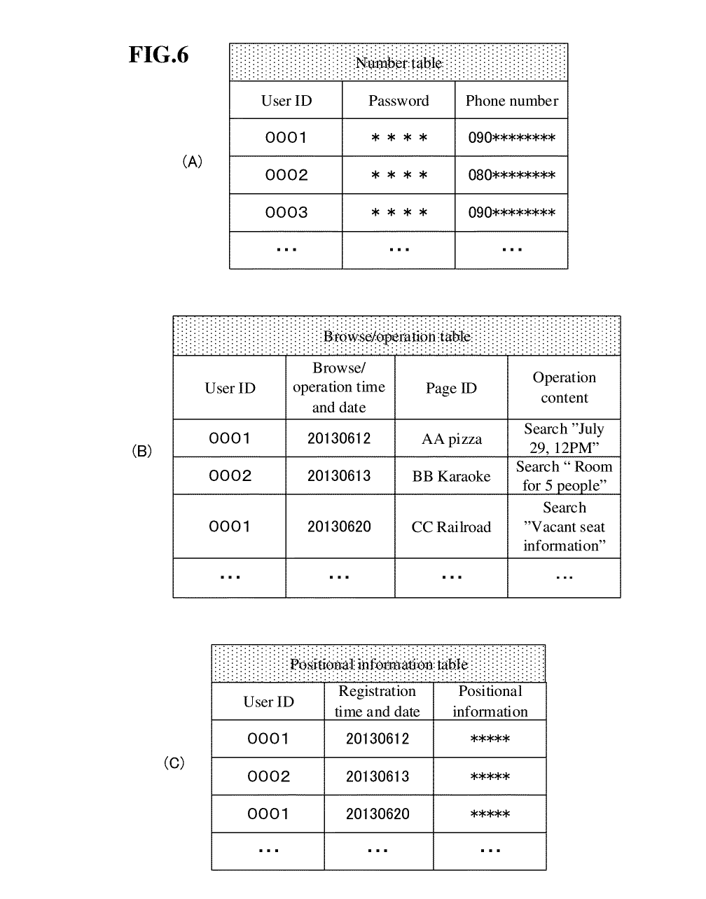

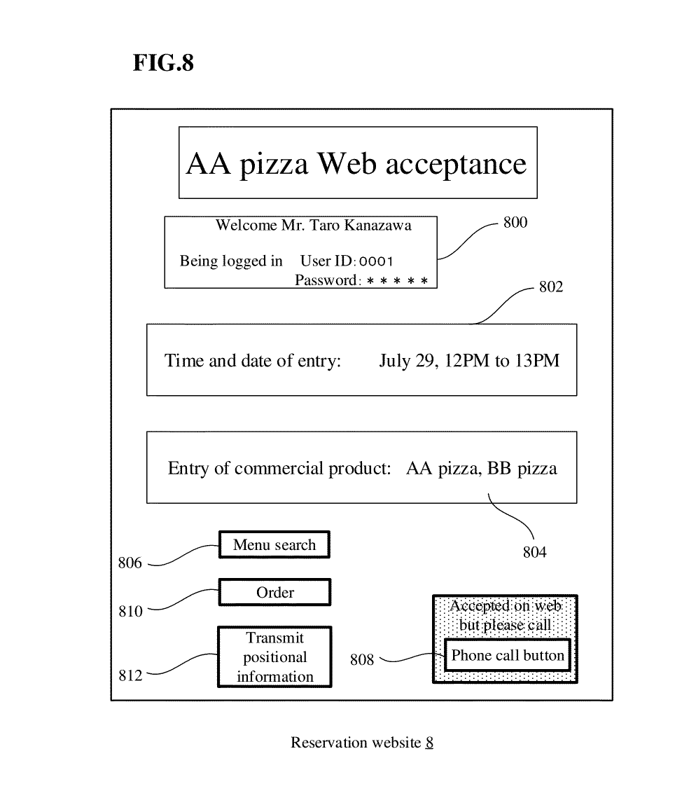

In the server program 72, in response to a request from a client terminal 3, the page providing section 720 provides the client terminal 3 with a web page for acceptance, and accepts an order or reservation. On the basis of a user ID and password input from a client terminal 3, the page providing section 720 of the present embodiment provides a reservation acceptance page exclusive to each client. In the reservation acceptance page, as shown in FIG. 8, an operation area (“phone call button” in the drawing) is provided for calling the acceptance device 2 by means of a telephone line. In the present embodiment, to give a client the right to access an exclusive reservation acceptance page, the page providing section 720 requests the client to register a user ID, password, and phone number and, as shown in FIG. 6(A), the section 720 registers the user ID, password and phone number of the client in the user information DB 750 such that the user ID, password and phone number are correlated with one another.

The access information registration section 722 registers in the access information DB 752 browse/operation information about client's browsing or operating a web page, provided by the page providing section 720, such that the browse/operation information is correlated with the phone number of the client terminal. As shown in FIG. 6B, the access information registration section 722 of the present embodiment 722 registers, in the access information DB 752, the page ID of a reservation acceptance page browsed or operated, the time and date when this page was browsed or operated, and operation contents such that these are correlated with a user ID. The registered browse/operation information (page ID, the time and date when the page was browsed or operated, and the operation contents) is correlated with the phone number of the client via the user ID.

The positional-information registration section 724 registers, in the positional information DB 754, the positional information of a client terminal, received from the client terminal 3, such that the positional information is correlated with the phone number of the client terminal 3. As shown in FIG. 6C as an example, the positional-information registration section 724 registers, in the positional information DB 754, positional information uploaded from the client terminal 3, the time and date (“registration time and date” in the drawing) when the positional information is uploaded, such that these are correlated with a user ID. The registered positional information and the registration time and date are correlated with the phone number of the client via the user ID.

In response to a request from the acceptance device 2, the transmitting section 726 transmits browse/operation information, registered by the access information registration section 722, to the acceptance device 2. Additionally, in response to a request from the acceptance device 2, the transmitting section 726 transmits positional information registered by the positional-information registration section 724 to the acceptance device 2. Upon receiving a phone number from the acceptance device 2, the transmitting section 726 of the present embodiment transmits to the acceptance device 2 the latest browse/operation information and positional information of the browse/operation information and positional information correlated with the phone number that the transmitting section 726 has received.

The call-button control section 728 controls a phone call button in a web page provided by the page providing section 720. Specifically, if the positional information of a client terminal 3 has not been registered in the acceptance server 7, the call-button control section 728 invalidates the phone call button because it may call the acceptance device 2. On condition that the positional information of the client terminal 3 has been registered in the acceptance server 7, the call-button control section 728 validates this phone call button.

The right management section 730 manages a browsing right and editorial right for a web page provided by the page providing section 720. On condition that a client terminal 3 has called the acceptance telephone 20 (i.e., the phone number of the client terminal 3 has been specified by the number specifying section 224), the right management section 730 of the present embodiment causes the transmitting section 726 to transmit browse/operation information and positional information correlated with the specified phone number, thus enabling the sharing of a web page and enabling a phone operator to edit the web page.

Next, operation of the acceptance system 1 will be described.

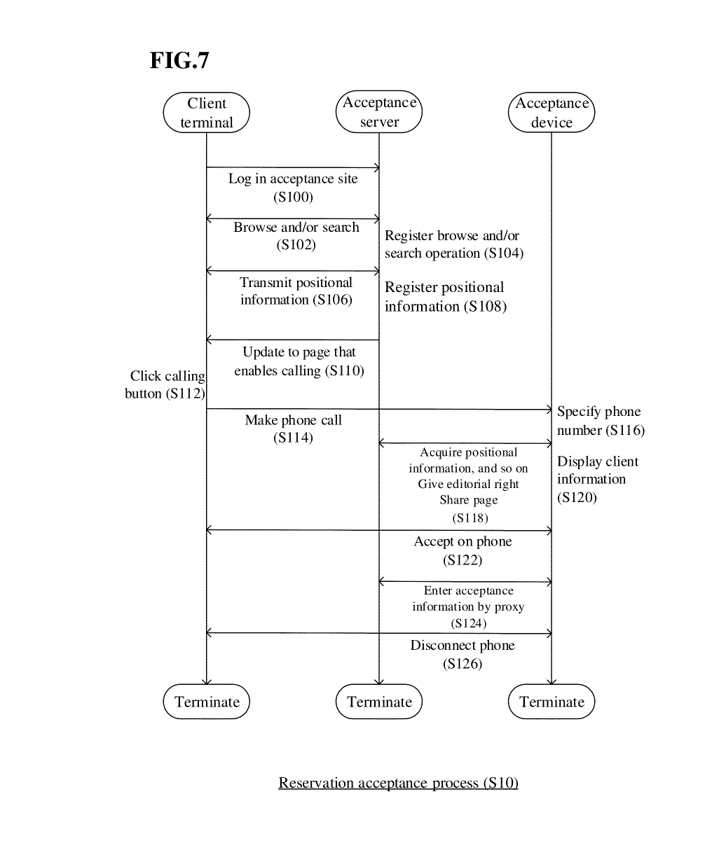

FIG. 7 is a sequence diagram for a reservation acceptance process (S10) in the acceptance system 1. In the present embodiment, a description is given using, as a concrete example, a case where a reservation for pizza delivery is accepted via a reservation website 8 shown in FIG. 8 as an example.

As shown in FIG. 7 as an example, in step 100 (S100), a client terminal 3 accesses a reservation website 8 (FIG. 8) provided by the acceptance server 7, and logs in the reservation website 8 exclusive to the client by use of a user ID and a password.

On the basis of the user ID and password received from the client terminal 3, the page providing section 720 of the acceptance server 7 specifies a user (client) and provides the client terminal 3 with the reservation website 8 exclusive to the client. The reservation website 8 includes: an input area 800 for logging in; a time and date input area 802 in which reservation time and date are input; a commercial product input area 804 in which a commercial product to be reserve-ordered is input; a search button 806 for menu search; an order button 810 for placing an order; a phone call button 808 for calling a phone acceptance; and a positional information transmission button 812 for registering positional information. Until positional information is transmitted, the phone call button 808 is invalidated and gray-out displayed.

In step 102 (S102), the client selects a date and time for a pizza delivery reservation, a commercial product to order, and so on by operating the client terminal 3.

In step 104 (S104), the access information registration section 722 of the acceptance server 7 successively registers, in the access information DB 752, the browse/operation information (browsed page ID, input character strings, a selected commercial product/products, browsing history, search results, and so on), entered on the reservation website through the client terminal 3, such that the browse/operation information is correlated with the user ID of this client.

In step 106 (S106), when the client clicks the positional-information transmission button 812 (FIG. 8) in order to give the pizza delivery destination, the client terminal 3 transmits GPS data to the acceptance server 7.

In step 108 (S108), the positional-information registration section 724 of the acceptance server 7 registers the GPS data received from the client terminal 3 in the positional information DB 754, such that the GPS data is correlated with the user ID of this client.

In step 110 (S110), the call-button control section 728 of the acceptance server 7 validates the phone call button 808 (FIG. 8) on the reservation website 8 being browsed by the client. Specifically, the call-button control section 728 causes the page providing section 720 to update the reservation website 8 to the one on which the phone call button 808 is validated.

In step 112 (S112), by clicking the phone call button 808, the client is able to switch to phone acceptance in the course of web acceptance.

In step 114 (S114), when the phone call button 808 is clicked, the client terminal 3 calls the acceptance telephone 20.

In step 116 (S116), when the acceptance telephone 20 receives a call from the client terminal 3, the number specifying section 224 of the acceptance device 2 specifies the phone number of the client terminal 3 on the basis of a number display signal.

In step 118 (S118), the access information acquiring section 220 of the acceptance device 2 informs the acceptance server 7 of the phone number specified by the number specifying section 224, and acquires, from the transmitting section 726 of the acceptance server 7, the latest browse/operation information correlated with the specified phone number.

The positional-information acquiring section 222 informs the acceptance server 7 of the phone number specified by the number specifying section 224, and acquires, from the transmitting section 726 of the acceptance server 7, the latest positional information (GPS data) correlated with the specified phone number.

The edit permitting section 226 informs the acceptance server 7 of the phone number specified by the number specifying section 224, and requests the right management section 730 of the acceptance server 7 for an editorial right for the website (the reservation website being browsed by the client) corresponding to the acquired page ID. The right management section 730 gives the acceptance device 2 the editorial right for the reservation website corresponding to the latest page ID associated with the informed phone number.

The page sharing section 228 informs the acceptance server 7 of the phone number specified by the number specifying section 224, and requests the right management section 730 of the acceptance server 7 for a browsing right for the website (the reservation website being browsed by the client) corresponding to the acquired page ID. The right management section 730 gives the acceptance device 2 the browsing right for the reservation website corresponding to the latest page ID associated with the informed phone number, and enables the client and a phone operator to share the reservation website 8 being browsed.

In step 120 (S120), the client information providing section 232 causes the display device 208 to display the browse/operation information acquired by the access information acquiring section 220, and the positional-information acquired by the positional-information acquiring section 222. Thus, the phone operator can take over the positional information of the client displayed on the display device 208, as a candidate place for delivery destination,

Additionally, the client information providing section 232 causes the display device 208 to display the reservation website 8 for which the browsing right is given by the page sharing section 228. Thus, the phone operator can take over acceptance of the pizza delivery reservation on the basis of information (the delivery date and time, commercial product name, and so on) entered by the client so far.

The browsing-history providing section 230 causes the display device 208 to display the browsing history acquired by the access information acquiring section 220. Thus, on the basis of the browsing history of the client, the phone operator can propose other commercial product or products which have not yet been ordered. This is because a commercial product or products in the website that the client viewed in the past may have highly attracted the client.

In step 122 (S122), while referring to the browse/operation information shown on the display device 208, the phone operator takes over acceptance of the reserve-order from the web acceptance, and while operating the acceptance device 2, the operator hears the content of the reserve-order from the client on the phone.

In step 114 (S124), according to operation by the phone operator and on the basis of the editorial right given by the right management section 730, the acceptance device 2 adds the content of the reserve-order accepted on the phone to the reservation website 8.

In step 116 (S116), upon completion of phone acceptance, the acceptance device 2 or client terminal 3 disconnects the telephone line in accordance with the operation performed by the phone operator or the client. After the phone is disconnected, the client can browse the reservation website 8 and check the content of the order, entered by the phone operator.

As just described, in the acceptance system 1, when a client switches from web acceptance to phone acceptance, information input via web acceptance or a browsed website can be taken over by a phone operator. This is convenient for the client, too, as the client does not have to place an order again from the beginning.

### Modified Example 1

Next, a modified example of the foregoing embodiment will be described.

In the foregoing embodiment, when switching takes place from web acceptance to phone acceptance, the client terminal 3 calls. However, in the modified example 1, the phone acceptance 20 calls.

In the modified example, when reservation acceptance has been dealt with, or when she or he comes to the store, the client is rewarded with a point/points.

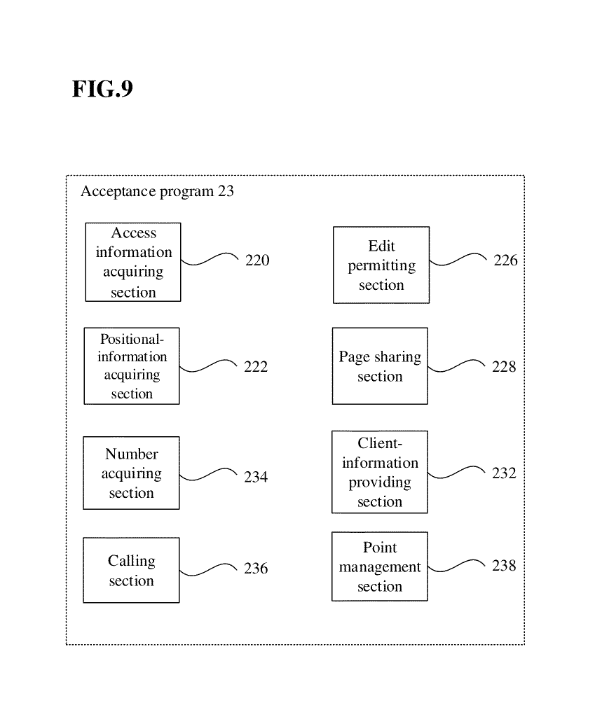

FIG. 9 is a diagram showing an example of the configuration of functions of an acceptance program 23 in the modified example 1. In the configuration shown in this diagram, functions substantially identical to those shown in FIG. 3 are labeled with reference signs identical to those in FIG. 3.

As shown in FIG. 9 as an example, the acceptance program 23 in the modified example 1 differs from the acceptance program 22 in FIG. 3 in that the number specifying section 224 is replaced by a number acquiring section 234 and, furthermore, a calling section 236 and a point management section 238 are added.

When a client registers her or his phone number in an acceptance server 7, the number acquiring section 234 acquires the registered phone number.

On the basis of the phone number acquired by the number acquiring section 234, the calling section 236 calls a client terminal 3 via a telephone line.

When a reserve-order accepted by an acceptance device 2 has been dealt with, or when the client comes to a place (e.g., a store) correlated with this reserve-order, the point management section 238 gives the client a point/points. For example, the point management section 238 gives a point/points according to the time taken from when the client registered her or his phone number in the acceptance server 7 to when the calling section 236 calls the client terminal 3 of this client. For example, the longer the time taken, the more points may be given.

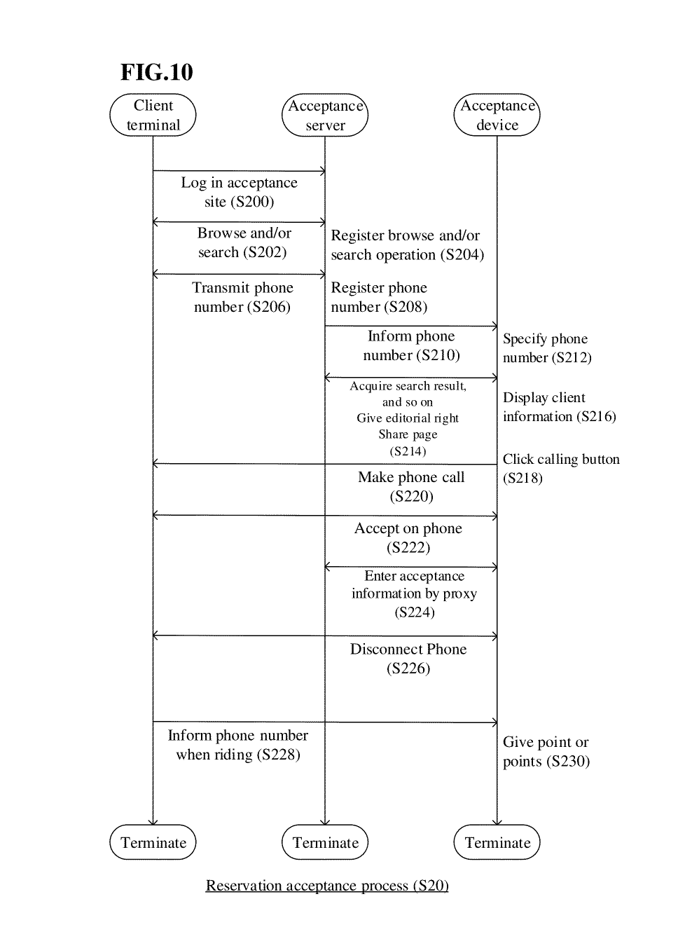

FIG. 10 is a sequence diagram for a reservation acceptance process (S20) in the modified example 1. In this example, the phone number of a client is not registered in the acceptance server 7 in initial registration, but when the client requests switching to phone acceptance, her or his phone number is registered. In this example, a description is given using, as a concrete example, a case where a taxi dispatch is accepted.

As shown in FIG. 10 as an example, in step 200 (S200), a client terminal 3 accesses a reservation website 8 (FIG. 8) provided by the acceptance server 7, and logs into the reservation website 8 exclusive to the client by use of a user ID and a password.

On the basis of the user ID and password received from the client terminal 3, a page providing section 720 of the acceptance server 7 specifies a user (client) and provides the client terminal 3 with the reservation website exclusive to the client. The reservation website provided has a phone number registration button 814 instead of the phone call button 808.

In step 202 (S202), the client enters a date and time for a vehicle dispatch reservation, the number of passengers, and so on by operating the client terminal 3.

In step 204 (S204), an access-information registration section 722 of the acceptance server 7 successively registers, in an access information DB 752, browse/operation information (browsed page ID, input character strings, and so on), entered on the reservation website through the client terminal 3, such that the browse/operation information is correlated with the user ID of this client.

In step 206 (S206), when the client clicks the positional-information transmission button 812 in order to give the vehicle dispatch destination, the client terminal 3 transmits the GPS data to the acceptance server 7. Additionally, in order to request switching to phone acceptance, the client enters the phone number of the client terminal 3 in the reservation website, and clicks the phone number registration button 814.

In step 208 (S208), a positional-information registration section 724 of the acceptance server 7 registers, in the positional information DB 754, the GPS data received from the client terminal 3, such that the GPS data is correlated with the user ID of this client.

Additionally, a page providing section 720 registers, in a user information DB 750, the phone number uploaded from the client terminal 3 via the reservation website.

In step 210 (S210), using the registration of the phone number of the client as a trigger, the transmitting section 726 of the acceptance server 7 transmits the registered phone number to the acceptance device 2 located nearest to the position indicated by the positional information.

In step 212 (S212), the number acquiring section 234 of the acceptance device 2 that has received the phone number receives the phone number from the transmitting section 726.

In step 214 (S214), on the basis of the phone number received by the number acquiring section 234, an access information acquiring section 220 acquires the browse/operation information of the client from the acceptance server 7.

On the basis of the phone number received by the number acquiring section 234, a positional-information acquiring section 222 acquires the positional information of the client from the acceptance server 7.

In step 216 (S216), a client information providing section 232 causes a display device 208 to display the browse/operation information acquired by the access information acquiring section 220, and the positional-information acquired by the positional-information acquiring section 222.

In step 218 (S218), the calling section 236 of the acceptance device 2 displays, on the display device 208, a call-button for calling the phone number acquired by the number acquiring section 234.

In step 220 (S220), when a phone operator clicks the call-button, the calling section 236 calls this phone number.

In step 222 (S222), while referring to the browse/operation information shown on the display device 208, the phone operator takes over the acceptance of reserve-order from web acceptance, and while operating the acceptance device 2, the operator hears the content of the reserve-order from the client on the phone.

In step 214 (S224), according to operation of the phone operator, the acceptance device 2 adds the content of the reserve-order accepted on the phone to the reservation website.

In step 216 (S216), upon completion of phone acceptance, the acceptance device 2 or client terminal 3 disconnects the telephone line in accordance with the operation performed by the phone operator or the client. After the phone is disconnected, the client can browse the reservation website and check the content of the order entered by the phone operator.

In step 228 (S228), when the client rides in a dispatched taxi, the client terminal 3 transmits its own phone number to the acceptance device 2.

In step 230 (S230), upon receiving the phone number from the client terminal 3 used when the reservation was accepted, the point management section 238 of the acceptance device 2 gives a point/points to this client.

As just described, in the acceptance system 1 of the modified example 1, when switching takes place from web acceptance to phone acceptance, the acceptance device 2 is able to call the client terminal 3. Additionally, giving a point/points can lead a client to an acceptance system in which web acceptance and phone acceptance are combined.

### Modified Example 2

In the embodiment described above, a description was given using an example where the acceptance device 2 and the acceptance server 7 are separate bodies. However, these may be integrated. Additionally, in the embodiment described above, a description was given using a form in which information (browse/operation information) to be provided to a phone operator is selected using, as a key, the phone number of a client terminal 3. However, using, as a key, the timing of the browse or operation of a homepage by the browsing terminal 3, information (browse/operation information) to be provided to a phone operator may be selected.

In the modified example 2, a description is given using the form in which an acceptance device 2 and an acceptance server 7 are integrated and, using, as a key, the timing of the browse or operation of a homepage by the browsing terminal 3, information is provided to a phone operator. This modified example is effective in medium or small enterprises where the possibility of simultaneous timing of web acceptance or phone acceptance is low.

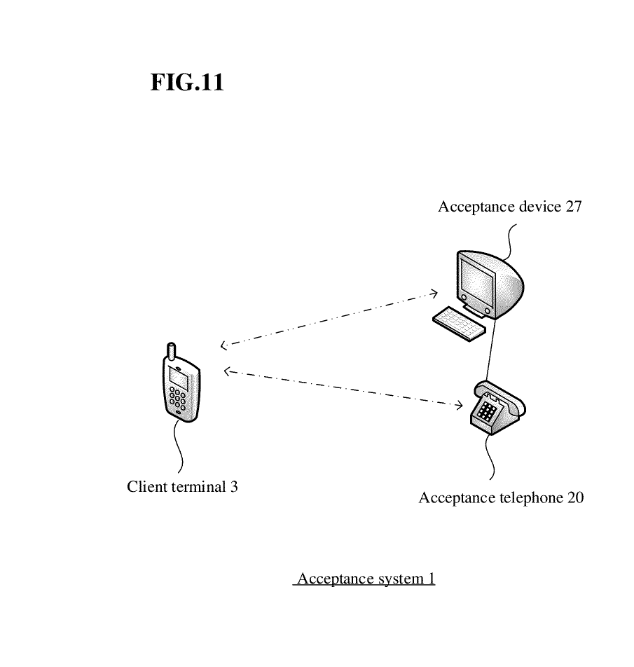

FIG. 11 is a diagram showing an example of the hardware configuration of an acceptance system 1 in the modified example 2.

As shown in FIG. 11 as an example, an acceptance device 27 has the function of a web server that conducts web acceptance together with the function of an acceptance device that assists in phone acceptance. As with the embodiment described above, the function of the acceptance device 27 may be allotted to two or more terminals.

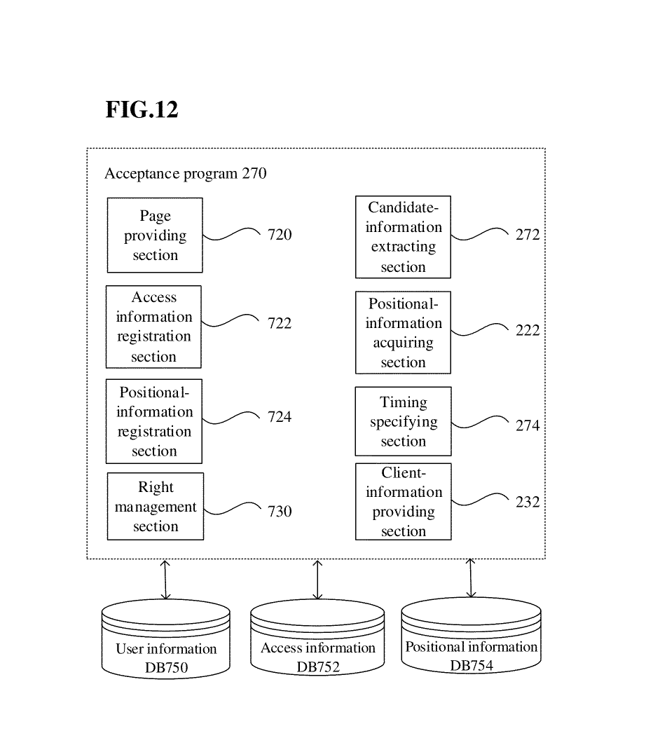

FIG. 12 is a diagram showing an example of the configuration of functions of the acceptance device 27.

As shown in FIG. 12 as an example, in the acceptance device 27 in this example, an acceptance program 270 is installed and, also, a user DB 750, access information DB 752, and positional information DB 754, are comprised.

The acceptance program 270 has a page providing section 720, access information registration section 722, positional-information registration section 724, right management section 730, candidate-information extracting section 272, positional-information acquiring section 222, timing specifying section 274, and client information providing section 232.

Part or all of the acceptance program 270 may be achieved by hardware such as an ASIC. The acceptance program 270 is stored in a recording medium, such as a CD-ROM or the like, and installed via this recording medium.

In the acceptance program 270, in response to a request from a client terminal 3, the page providing section 720 provides the client terminal 3 with a web page for acceptance, and accepts an order or reservation.

The access information registration section 722 registers, in the access information DB 752, browse/operation information about a client terminal's browsing or operating a web page, provided by the page providing section 720, such that the browse/operation information is correlated with the timing of the client terminal's browsing or operating the webpage. The access information registration section 722 of this example registers, in the access information DB 752, the page ID of a reservation acceptance page browsed or operated, the time and date when this page was browsed or operated, and operation contents such that these are correlated with the time and date when this page was browsed or operated. From the viewpoint of the protection of personal information, the access information registration section 722 may sequentially delete, from the access information DB 752, browse/operation information that has been registered therein for a prescribed time.

The positional-information registration section 724 registers, in the positional information DB 754, positional information uploaded from the client terminal 3, the time and date (“registration time and date” in the drawing) when the positional information is uploaded, such that these are correlated with a user ID. From the viewpoint of the protection of personal information, the positional-information registration section 724 may sequentially delete, from the positional information DB 754, positional information that has been registered therein for a prescribed time.

The right management section 730 manages a browsing right and editorial right for a web page provided by the page providing section 720. On condition that the acceptance telephone 20 receives an incoming call from the client terminal 3, the right management section 730 of this example gives the phone operator who has received the incoming call, a browsing right and operating right for a web page corresponding to the browse/operation information (page ID) extracted by the candidate-information extracting section 272.

On the basis of the timing of reception of an incoming call, specified by the timing specifying section 274, the candidate-information extracting section 272 extracts candidate browse/operation information from among pieces of browse/operation information registered in the access information DB752. For example, using, as a reference time, the timing of reception of an incoming call, specified by the timing specifying section 274, the candidate-information extracting section 272 displays, on the display device 208, candidate browse/operation information registered during a period from a prescribed time before the reference time to the reference time. The section 272 allows the phone operator to make a selection from this period, and determines the browse/operation information of a client from the candidate browse/operation information on the basis of a selection operation by the phone operator. Using, as a reference time, the timing of reception of an incoming call, specified by the timing specifying section 274, the candidate-information extracting section 272 of this example displays on the display device 208 the candidate browse/operation information registered during a period from 30 minutes before the reference time to the reference time. The browse/operation information includes, in addition to a page ID, a user ID and operation contents (e.g., search conditions). The phone operator inquires about a user ID and so on from a client on the phone. Thereby, the phone operator selects the browse/operation information of the client from the candidate browse/operation information.

On the basis of the browse/operation information (specifically, a user ID) determined by the candidate-information extracting section 272, the positional-information acquiring section 222 acquires the positional information of the client terminal 3 from positional information registered in the positional information DB 754.

On the basis of a calling signal from the phone from the client terminal 3, the timing specifying section 274 specifies the timing of reception of the signal from the client terminal 3. The timing may be, for example, time and date, only time, or only the timing of reception of a call.

On the basis of a timing specified by the timing specifying section 274 and the browse/operation information registered in the access information DB 752, the client information providing section 232 provides information about the contents of browse or operation performed by a client on a web page. For example, on the basis of browse/operation information determined by the candidate-information extracting section 272, the client information providing section 232 causes the display device 208 to display the browse/operation information of the client currently engaged with a phone operator.

In the foregoing configuration, using, as a key, the timing of reception of an incoming call from a client terminal 3, the acceptance device 27 in the modified example 2 extracts browse/operation information indicating the contents of browse or operation of a web page, and provides a phone operator with the browse/operation information thus extracted.

### INDUSTRIAL APPLICABILITY

The present invention can be applied to an acceptance service combining both web acceptance and phone acceptance.

### REFERENCE SIGNS LIST

1: Acceptance system
2: Acceptance device
20: Acceptance telephone
7: Acceptance server

What is claimed is:

1. An acceptance device comprising:
an access information acquiring section that acquires browse/operation information about browse or operation of a web page by a client such that the information is correlated with the phone number of the client;
a number specifying section that specifies the phone number of the client on the basis of a call signal from a phone call made by the client; and
a client information providing section that provides information indicating a content browsed or operated on the web page by the client, on the basis of the phone number specified by the number specifying section and the browse/operation information acquired by the access information acquiring section.

2. The acceptance device according to claim 1,
wherein the access information acquiring section acquires, as the browse/operation information, information about search conducted on the web page in accordance with an instruction from the client, and
wherein the client information providing section provides a phone operator currently engaged with a phone due to the call signal, with information about the latest search of the searches conducted on the web page by the client.

3. The acceptance device according to claim 2,
wherein the web page is a reservation reception site,
wherein the access information acquiring section acquires at least information specifying an object for reservation and information about reservation time and date, and
wherein the client information providing section provides the phone operator with information about the object for the reservation and the reservation time and date in the latest search.

4. The acceptance device according to claim 1,
wherein the access information acquiring section acquires, as the browse/operation information, information specifying the web page accessed most recently by the client,
wherein the client information providing section provides an operator currently engaged with the phone due to the call signal, with the web page accessed most recently by the client, on the basis of information acquired by the access information acquiring section,
wherein the acceptance device further comprises an edit permitting section that gives the phone operator an editorial right for the web page provided by the client information providing section, and
wherein, the web page browsed or operated by the client is shared with the phone operator.

5. The acceptance device according to claim 1, further comprising a positional-information acquiring section that acquires positional information about the client,
wherein the client information providing section provides a phone operator currently engaged with a phone due to the call signal, with information indicating content browsed or operated on the web page by the client and positional information about the client acquired by the positional-information acquiring section.

6. An acceptance system including a client terminal, a web server, and an acceptance device,
wherein the client terminal browses or operates a web page provided by the web server,
wherein the web server includes:
an access information registration section that registers browse/operation information about the browse or operation of the web page by the client terminal, such that the information is correlated with a phone number of the client terminal; and
a transmitting section that transmits browse/operation information registered by the access-information registration section, to the acceptance device in accordance with a request from the acceptance device,
wherein the acceptance device comprises:
an access information acquiring section that acquires, from the web server, the browse/operation information registered by the access information registration section, such that the information is correlated with the phone number of the client;
a number specifying section that specifies the phone number of the client terminal on the basis of a call signal from a phone call made by the client; and
a client information providing section that provides information indicating a content browsed or operated on the web page by the client, on the basis of the phone number specified by the number specifying section and the browse/operation information acquired by the access information acquiring section.

7. The acceptance system according to claim 6,
wherein the client terminal transmits the positional information of the terminal to the web server,
wherein the web server further comprises a positional-information registration section that registers the positional information of the client terminal received from the client terminal, such that the information is correlated with the phone number of this client terminal,
wherein the access information acquiring section acquires browse/operation information registered by the access information registration section, and positional information registered by the positional-information registration section, and
wherein the client-information providing section provides information indicating content browsed or operated on the web page and information indicating the position of the client terminal, on the basis of the phone number specified by the number specifying section.

8. The acceptance system according to claim 7,
wherein, on condition that the positional information of the terminal is transmitted to the web server, the client terminal is enabled to call the acceptance device.

9. The acceptance system according to claim 8,
wherein, on condition that the phone number of the client terminal is specified by the number specifying section, the access information acquiring section acquires browse/operation information correlated with the specified phone number from the web server.

10. The acceptance system according to claim 6,
wherein the web server further comprises a page providing section that provides the client terminal with a web page in which an operation area for calling the acceptance device is included,
wherein the access information registration section registers browse/operation information about a client's browsing or operating a web page, provided by the page providing section, such that the browse/operation information is correlated with the phone number of the client terminal.

11. An acceptance system including a client terminal, a web server, and an acceptance device,
wherein the client terminal browses or operates a web page provided by the web server, and transmits a phone number such that the phone number is correlated with the web page,
wherein the web server comprises:
an access information registration section that registers browse/operation information about browse or operation of the web page by the client terminal, such that the information is correlated with a phone number received from the client terminal;
and a transmitting section that transmits browse/operation information registered by the access-information registration section and the phone number, to the acceptance device in accordance with a request from the client terminal,
wherein the acceptance device comprises:
an access information acquiring section that acquires, from the web server, browse/operation information registered by the access information registration section, such that the information is correlated with the phone number of the client;
a number acquiring section that, when the phone number is registered in the web server, acquires the phone number of the registered client terminal;
a client information providing section that provides information indicating content browsed or operated on the web page by the client, on the basis of the phone number acquired by the number acquiring section and the browse/operation information acquired by the access information acquiring section; and
a calling section that calls the client terminal via a telephone line on the basis of the phone number acquired by the number acquiring section.

12. An acceptance device comprising:
an access information registration section that registers browse/operation information about browse or operation of a web page by a client terminal such that the information is correlated with the timing of the browse or operation by the client terminal;
a timing specifying section that specifies the timing of reception of an incoming call from the client terminal, on the basis of a call signal from a phone call made by the client terminal; and
a client information providing section that provides information indicating contents browsed or operated on the web page, on the basis of browse/operation information registered by the access information registration section and a timing specified by the timing specifying section.

13. An acceptance method, comprising:
a step of a client terminal's browsing or operating a web page provided from a web server;
a step of the web server's registering browse/operation information about the browse or operation of the web page by the client terminal, such that the information is correlated with a phone number of the client terminal;
a step of the client terminal's calling an acceptance device via a telephone line;
a step of the acceptance device's specifying the phone number of the client terminal on the basis of a call signal from a phone call made by the client terminal;
a step of the acceptance device's acquiring, from the web server, the browse/operation information registered correlated with the phone number; and
a step of the acceptance device's providing a phone operator with information about a content browsed or operated on the web page by the client, on the basis of acquired browse/operation information.

14. A program causing a computer to perform:
a step of displaying a link for accessing a web page;
a step of transmitting positional information to a web server currently providing the web page, the positional information indicating a position when the web page is being browsed or operated, and the positional information being correlated with the phone number; and
a step of, on condition that transmission of the positional information is completed, starting to call a phone number that conducts an acceptance service correlated with the web page.
